(19) United States
(12) Patent Application Publication
(10) Pub. No.: US 2026/0365225 A1
(43) Pub. Date: Nov. 19, 2026

(54) STEERING COLUMN FOR A MOTOR VEHICLE AND ENERGY ABSORPTION ELEMENT FOR A STEERING COLUMN

(71) Applicants: thyssenkrupp Presta AG, Eschen (LI); thyssenkrupp AG, Essen (DE)

(72) Inventors: Remo LAMPERT, Feldkirch (AT); Thomas RAICH, Vandans (AT); Markus DOMIG, Bartholomaeberg (AT); Tobias HEEB, Ruggell (LI)

(73) Assignees: thyssenkrupp Presta AG, Eschen (LI); thyssenkrupp AG, Essen (DE)

(21) Appl. No.: 19/514,960

(22) PCT Filed: Aug. 23, 2024
(86) PCT No.: PCT/EP2024/073765

§ 371 Date: Feb. 27, 2026

(30) Foreign Application Priority Data
Aug. 28, 2023 (BE) BE 2023/5711

(51) Int. Cl. B62D 1/19; B62D 1/185

(52) U.S. Cl. CPC B62D 1/192; B62D 1/185

(57) ABSTRACT

A steering column for a motor vehicle comprises a second component which can be displaced in a longitudinal direction relative to a first component, wherein attached between the first component and the second component is an energy-absorption element which comprises at least one U-shaped bending strip which has a first limb which extends in the longitudinal direction in a first plane, is secured to the first component, and is connected via a bend to a second limb which extends in a longitudinal direction in a second plane spaced apart from the first plane and is secured to the second component, wherein a breakaway device is provided which is configured such that it breaks away when a predetermined crash force is exceeded and frees the first component to move relatively relative to the second component in a longitudinal direction. In order to enable improved responsiveness when breakaway takes place, the invention proposes that the breakaway device has a connection, detachable in a longitudinal direction, between the second limb and the first component.

### PRIOR ART

The invention relates to a steering column for a motor vehicle which has a second component which can be displaced in a longitudinal direction relative to a first component, wherein attached between the first component and the second component is an energy-absorption element which comprises at least one U-shaped bending strip which has a first limb which extends in the longitudinal direction in a first plane, is secured to the first component, and is connected via a bend to a second limb which extends in a longitudinal direction in a second plane spaced apart from the first plane and is secured to the second component, wherein a breakaway device is provided which is configured such that it breaks away when a predetermined crash force is exceeded and frees the first component to move relatively relative to the second component in a longitudinal direction.

A generic steering column has a so-called crash device or crash system for increasing the safety of occupants in the event of a vehicle impact, a so-called crash. Such a crash device provides that a first component, for example the inner casing of a setting unit, at which the steering wheel is attached for the driver, can be displaced forward in a longitudinal direction, i.e. in the direction of travel, relative to a second component, for example an outer casing which is supported by a support unit, fixed to the body, of the steering column. If, in the event of an impact, a person strikes the steering wheel at high speed, a relatively high force—the so-called crash force—is exerted on the steering wheel which exceeds a threshold value which occurs only in the event of a crash.

In order to reduce the risk of injury to the person hitting the steering wheel in the event of a crash, it is known to integrate between the support unit and the setting unit an energy-absorption device which enables controlled deceleration of the body which is as smooth as possible.

The energy-absorption device has at least one energy-absorption element which is attached between the first and the second component. The energy-absorption element generically has at least one bending strip. The latter has a U-shaped form with a first limb which transitions into a second limb via a U-shaped bend. The first limb extends forward in a longitudinal direction in a first plane in which it is fixed to the first component, for example on the radial outer side of an inner casing. The second limb extends substantially parallel to the first limb in a second plane which is spaced apart normally from the first plane, and is fixed to the second component, likewise preferably forward viewed from the bend. In the case of a relative movement of the components in the event of a crash, as the plastic deformation continues, the second limb passes through the bend into the first limb, as a result of which kinetic energy is absorbed by conversion into heat and the ability to deform, and controlled smoothed deceleration of the body which has struck the steering wheel is effected.

In order to ensure that the bending strip is not deformed other than in the event of a crash and its function is not affected, for example by a high degree of force being exerted inadvertently or improperly to the steering wheel, it is known to provide a breakaway device. This ensures that, during normal operation and also when under high stress, the components and thus also the limbs of the bending strip are held in position relative to one another. In the event of a peak stress which occurs only in the event of a crash, however, a predetermined force threshold is exceeded by the crash force, as a result of which the breakaway device is suddenly detached and frees the components to move relatively in order to deform the bending strip.

Such a breakaway device is described, for example, in US 2022/0126907 A1. It has a pin-shaped predetermined breakaway element which extends transversely through the first and the second limb of the bending strip such that the two limbs are connected to each other and a relative movement for the purpose of energy absorption can be effected only when the predetermined breakaway element is severed by the exertion of the crash force. In principle, although a force threshold can consequently be enabled, it is disadvantageous that the two limbs have to have fastening means for the predetermined breakaway element, for example through openings, as a result of which the deformation behavior and the functioning are adversely affected. The functioning can also be disrupted by the broken parts of the predetermined breakaway element which remain after severing in the event of a crash. It is furthermore problematic that the predetermined breakaway element has to span the normal distance between the two limbs such that, when stressed by a crash, uncontrolled tilting in the longitudinal direction is unavoidable, as a result of which maintaining a defined force threshold which is crucial for reproducible breakaway behavior is problematic. Given the fact that perfect functioning of the energy-absorption device is very relevant in terms of safety, these disadvantages are not acceptable.

Given the problems explained above, the object of the present invention is to enable improved responsiveness when breakaway takes place.

### DESCRIPTION OF THE INVENTION

This object is achieved according to the invention by the steering column according to claim 1. Advantageous developments can be found in the dependent claims.

In the case of a steering column for a motor vehicle, said steering column having a second component which can be displaced in a longitudinal direction relative to a first component, wherein attached between the first component and the second component is an energy-absorption element which comprises at least one U-shaped bending strip which has a first limb which extends in the longitudinal direction in a first plane, is secured to the first component, and is connected via a bend to a second limb which extends in a longitudinal direction in a second plane spaced apart from the first plane and is secured to the second component, wherein a breakaway device is provided which is configured such that it breaks away when a predetermined crash force is exceeded and frees the first component to move relatively relative to the second component in a longitudinal direction, it is provided according to the invention that the breakaway device has a connection, detachable in a longitudinal direction, between the second limb and the first component.

The first and second limbs are together also referred to below in short as the two limbs or in short as the limbs. They extend at least substantially parallel to each other in two normally spaced-apart planes. The distance between the limbs corresponds to the distance, measured in the normal direction, between the said first and second plane. The limbs are connected to each other via the bend which constitutes a portion which is curved in longitudinal section, and both extend, viewed therefrom, in a longitudinal direction. Correspondingly, the free ends of the limbs face away, viewed from the bend, in a longitudinal direction, for example backward with respect to the driving direction.

The breakaway device is arranged actively between the first component and the second component, wherein, in a known fashion, the first limb is secured undetachably to the first component and the second limb to the second component. According to the invention, the second limb is, however, additionally fixed to the first component via a connection which can be detached, i.e. can be broken, in the longitudinal direction, such that the breakaway device is incorporated actively between the second limb and the first component. In other words, the detachable connection between the second limb and the first component is arranged, with respect to the force imparted between the components in the event of a crash, parallel to the fixed undetachable connection between the first limb and the first component. This represents an essential difference from the mentioned prior art in which the second limb is connected only to the first limb via the predetermined breakaway element such that this detachable connection is arranged in series with the fixed connection of the first limb to the first component.

The breakaway device according to the invention can be arranged outside the portions of the limbs which can be deformed in the event of a crash. This results in the significant advantage that the force required for breakaway, which is also referred to as the breakaway force, is exerted on the detachable connection directly between the second limb and the first component and is not transmitted to the first limb as in the prior art. As a result, the bending strip is not stressed by the breakaway force and the two limbs can be deformed plastically unhindered in the event of a crash. The deformation is not, as in the prior art, adversely affected by fastening means of predetermined breakaway elements such that the responsiveness of the breakaway device and the energy-absorption characteristics of the bending strip can be optimized independently of each other. More reproducible breaking behavior and thus improved functioning of the energy-absorption device can be achieved.

It is advantageous that the connection is formed directly between the second limb and the first component. The direct connection is characterized in that the two limbs directly contact the first component, for example lie against it, and to be precise the first limb via the undetachable connection, and the second limb via the detachable connection of the breakaway device. In other words, the connections of the two limbs are arranged parallel to the first component with respect to the action of the crash force. The direct connection has the advantage that the breakaway device can be configured flexibly and freely in terms of structure, for example by the use of breaking or shearing elements, friction elements and/or the like, without adversely affecting the energy-absorption function of the bending strip.

It is preferred that the connection is formed only between the second limb and the first component. It is thus in particular intended that the breakaway device has no direct connection between the first limb and the second limb. This is advantageous in terms of independent optimization of the bending strip and the breakaway device.

It is possible that the second limb has a connecting portion which has the breakable connection of the breakaway device. The connecting portion can preferably be implemented in the end region directed away in the longitudinal direction, viewed from the bend. This region is not deformed for the purpose of energy absorption and enables the structure of the breakable connection to the first component to be adapted simply.

In the abovementioned embodiment, it is advantageous that the connecting portion extends at least partially in the first plane. The connecting portion of the second limb can here be formed flush with the first limb, i.e. the outer surface of the first limb facing the first component and the inner side, situated on the same side and likewise facing the first component, of the connecting portion are preferably situated in the same plane in which they can lie preferably directly against the outer side of the first component and are fixed thereto. On this outer side, the first limb is secured fixedly and undetachably and the connecting portion is fixed parallel thereto via the detachable connection so that it can break away. The arrangement in the same plane enables simple adaptation and mounting on the first component.

The abovementioned embodiment can be implemented structurally simply by the second limb being formed with a step. By virtue of the step-like profile, the connecting portion is, viewed from the second limb, arranged offset in parallel in the first plane. This can be implemented by the second limb first being bent or curved toward the first limb in its free end portion facing away from the bend in a longitudinal direction and then being angled in the opposite direction such that a step height is formed which corresponds to the normal distance from the first limb perpendicular to the second limb. As a result, the end portion of the connecting portion is situated normally with respect to the first plane at the same height as the first limb.

It can advantageously be provided that the breakaway device is spaced apart from the first limb in the longitudinal direction. The detachable connection of the breakaway device can be arranged spaced apart from a free end of the first limb, which end is averted from the bend in the longitudinal direction. The connecting portion protrudes beyond the first limb in this direction. As a result, sufficient structural space for the breakaway device can be supplied simply in the longitudinal direction.

It is possibly characterized in that the connecting portion has a sliding shoe. The sliding shoe here has a slot-shaped through opening in the normal direction which is open in the longitudinal direction on one side. A fastening element, for example a rivet, a threaded bolt, or the like, is passed through said opening normally to the first plane and is connected to the first component. As a result, the connecting portion can be clamped frictionally to the first component in order to produce a detachable frictional connection directly between the second limb and the first component. When, in the event of a crash, a crash force acts in the longitudinal direction between the first and second component which is greater than the frictional force acting between the sliding shoe and the first component, the frictional connection is detached. The fastening element is thus moved out of the fork opening by overcoming the frictional force, as a result of which the sliding shoe breaks away from the first component. As a result, the second limb is freed to move relative to the first limb such that the first component moves relative to the second component with continuous plastic deformation of the bending strip and is thus decelerated.

An advantage of the frictional detachable connection is that no broken pieces occur when breakaway takes place which can adversely affect the functioning. Moreover, the responsiveness or breakaway behavior can be predetermined simply and within wide limits by adjusting the frictional force.

Alternatively, an opening which is closed in the longitudinal direction and through which a predetermined breakaway element, for example a shearing pin or the like, is passed can also be provided. An advantage compared with the prior art is that better shearing behavior can be achieved than in the case of the predetermined breaking pin guided freely over the normal distance between the limbs.

It can preferably be provided that an electromotive linear actuator is arranged between the first component and the second component. Said linear actuator has a linear drive, for example a spindle drive, which can be driven by an electric motor, in which a spindle nut and a threaded spindle engaging in the latter can in a manner known per se be driven in rotation relative to each other. Because the linear actuator engages at the first and second components which can be adjusted relative to each other, motorized adjustment can be effected.

It is possible that the first component and the second component comprise casings which can telescope in the longitudinal direction. The casings can have telescopically nested casing tubes which can be retracted and extended in the longitudinal direction in order to form a length-adjustable casing unit. For example, an inner casing can be provided in which a steering spindle with a manual steering handle attached thereto is rotatably mounted, and which is accommodated in an outer casing so that it is telescopically adjustable in the longitudinal direction, said outer casing for its part being retained on the vehicle body via a support unit. The energy-absorption device according to the invention can advantageously be arranged between the casings, wherein the first limb of the bending strip can be fixed to the outer side of the inner casing, and the second limb to the inner side of the outer casing, and additionally with the connecting portion on the inner casing.

The bending strip can preferably have a shaped sheet metal part. Such a shaped sheet metal part can preferably be manufactured efficiently as a one-piece pressed and stamped part, preferably made from sheet steel.

In the case of an energy-absorption element for a steering column of a motor vehicle, comprising at least one U-shaped bending strip which has a first limb which extends in a first plane in a longitudinal direction and has first fastening means for connection to a first component of the steering column, and is connected via a bend to a second limb which extends in a longitudinal direction in a second plane spaced apart from the first plane and has second fastening means for connection to a second component of the steering column, it is provided according to the invention that the second limb has a connecting portion which extends at least partially in the first plane.

The fastening means at the limbs are designed to produce fixed undetachable connections to the components. They can have, for example, fastening openings through which rivets, screws, or the like can be passed and be connected fixedly to the components. Form-fitting elements or the like can also be provided which can supply form-fitting support in the longitudinal direction. The connecting portion has connecting means which can be detachable under the action of a crash force above a predetermined threshold value in the longitudinal direction, for example by a detachable friction fit or the like, as described above.

The connecting portion is arranged perpendicularly to the planes viewed in the normal direction at the same height as the first limb. As a result, the second limb can be fixed to the first component via the detachable connection in the same plane as the first limb via the undetachable connection.

The energy-absorption element can preferably be used in a steering column according to the invention and it can have all the features which are described above in connection with the steering column according to the invention.

For example, the second limb can be designed with a step and/or the connecting portion can have a sliding shoe.

It is furthermore advantageous that the connecting portion protrudes beyond the first limb in the longitudinal direction. As a result, the breakaway device according to the invention can be arranged on the connecting portion spaced apart in the longitudinal distance from the fixing point of the first limb to the first component.

### DESCRIPTION OF THE DRAWINGS

Advantageous embodiments of the invention will be explained in detail below on the basis of the drawings, in which, in detail:

FIG. 1 shows a steering column according to the invention in a schematic perspective illustration,

FIG. 2 shows an enlarged detailed view of the energy-absorption device of the steering column in FIG. 1,

FIG. 3 shows a partial view of a longitudinal section through the steering column in FIG. 1,

FIG. 4 shows a bending strip according to the invention of the steering column in FIGS. 1-3 in an isolated perspective view,

FIG. 5 shows a side view of the bending strip in FIG. 4.

### EMBODIMENTS OF THE INVENTION

In the various Figures, the same parts have at all times been provided with the same reference signs and are therefore generally also named or mentioned in each case only once.

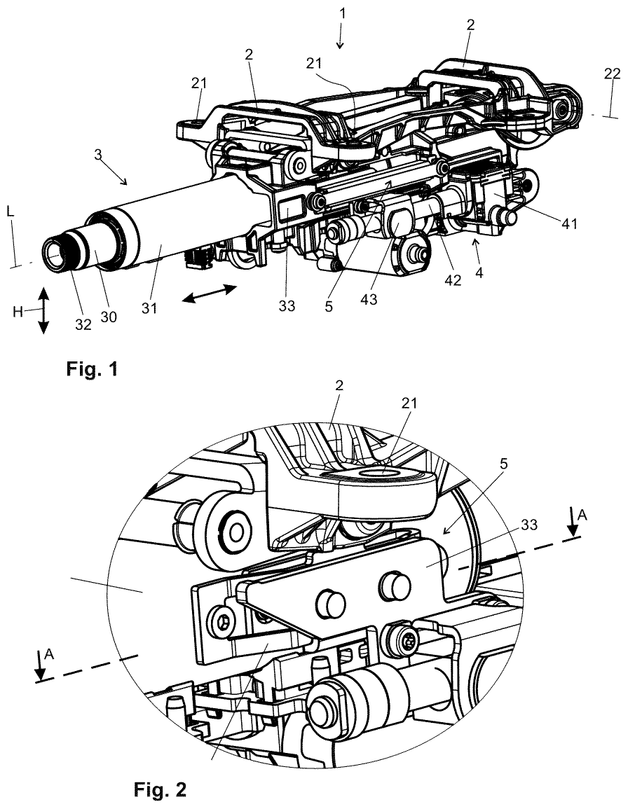

A steering column 1 according to the invention is illustrated schematically in FIG. 1 in a perspective view obliquely from behind, relative to the driving direction of a motor vehicle (not shown).

The steering column 1 can be fastened to the body of a motor vehicle by means of a support unit 2. For the purpose of connection to the vehicle body, the support unit 2 comprises securing means 21 which can take the form of fastening openings.

A setting unit 3 comprises a steering spindle 30 which is mounted in an inner casing 31, also referred to as an inner casing tube, so that it can rotate about its longitudinal axis L which extends in the longitudinal direction. Formed at the rear end portion at the steering spindle 30 is a fastening portion 32 for fastening a steering wheel (not illustrated) for manually inputting steering commands. The inner casing 31 forms a first component within the meaning of the invention.

The inner casing 31 is accommodated and retained so that it can be shifted telescopically in the longitudinal direction in an outer casing 33, also referred to as an outer casing tube, outer casing unit, or guide box, as indicated with the double-headed arrow. The outer casing 33 forms a second component within the meaning of the invention.

In order to effect a height adjustment, the outer casing 33 is mounted on the support unit 2 so that it can pivot about a horizontal pivot axis 22 lying transversely to the longitudinal axis L, such that the steering spindle 30 can be moved up and down in a vertical direction H, as indicated with the double-headed arrow.

A linear actuator 4, which takes the form of a rotary spindle drive, is used for length adjustment. It has a motorized drive unit 41 attached to the outer casing 33 and supported in the longitudinal direction. Said drive unit has an electric motor by which a threaded spindle 42 can be driven in rotation about its spindle axis. The spindle axis lies parallel to the longitudinal axis L.

The threaded spindle 42 engages with its outer thread in a spindle nut 43 which is fixed in terms of rotation about the spindle axis. The spindle nut 43 is connected to the inner casing 31 and supported in the longitudinal direction. Correspondingly, driving of the threaded spindle 42 in rotation by drive unit 41 results in axial linear displacement of the spindle nut 45, as a result of which the inner casing 31 can be adjusted in the longitudinal direction relative to the outer casing 33, i.e. can be retracted or extended telescopically.

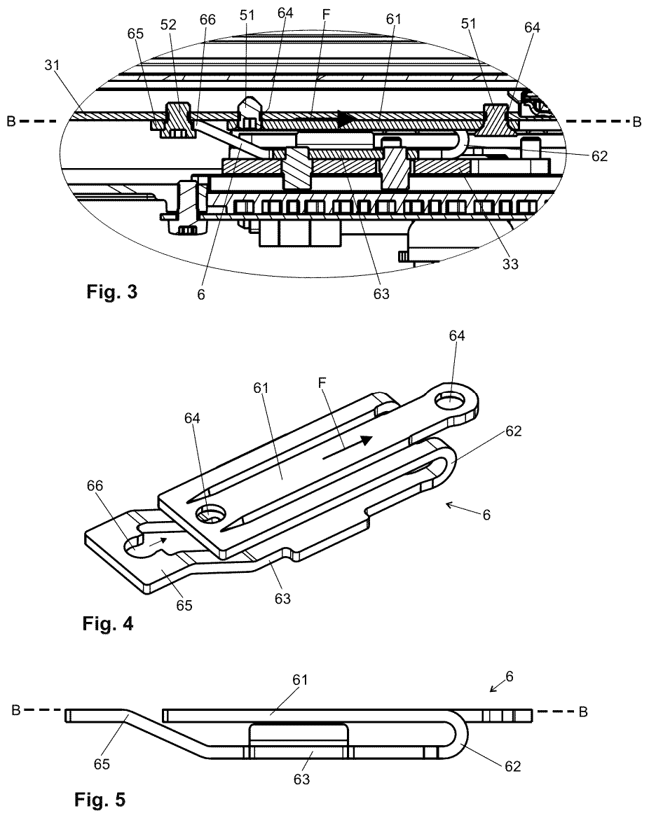

An energy-absorption device 5, which has a bending strip 6 configured according to the invention as an energy-absorption element, is integrated between the inner casing 31 and the outer casing 33. The arrangement is shown in FIG. 2 in an enlarged view of FIG. 1 and in FIG. 3 in a longitudinal section A-A parallel to the longitudinal axis L, viewed from above with respect to FIG. 2.

FIG. 4 shows the bending strip 6 separately in a perspective view and FIG. 5 shows it in a side view as in FIG. 3.

The bending strip 6 has a first limb 61 which extends in the longitudinal direction and transitions via a bend 62 into a second limb 63.

The first limb 61 has fastening means 64 in the form of through fastening openings. Fastening elements 51, for example rivets or the like, are passed through said fastening openings and are connected to the inner casing 31. The inner limb 61 here lies with its inner side, radially facing the longitudinal axis L, in a fastening plane B (see FIG. 3) directly against the outer side of the inner casing 31 and is secured thereto undetachably.

The second limb 63 lies parallel to the first limb 61 in a second plane spaced apart normally from the first plane B.

The second limb 63 has similarly configured fastening means 64 in the form of through fastening openings. Likewise, fastening elements 51, for example rivets or the like, are passed through said fastening openings. As a result, the second limb is fixedly and undetachably connected to the outer casing 33.

At its free end portion averted from the bend 62 in the longitudinal direction, the second limb 63 has a connecting portion 65. The latter has a slot-shaped through opening 66 in the normal direction which is open on one side in the longitudinal direction, as indicated in FIG. 4 with the arrow. A sliding shoe is formed at the connecting portion 65 by the opening 66 open on one side.

According to the invention, the second limb 63 is configured with a step in longitudinal section such that the connecting portion 65 lies in the same plane as the first limb 61, i.e. is formed flush with the latter. Correspondingly, the inner side, facing the longitudinal axis L, of the connecting portion 65 lies in the fastening plane B, as can be seen in FIGS. 3 and 5.

A fastening element 52, for example a rivet, threaded bolt, or the like, is passed through the opening 66 and connected to the inner casing 31. As a result, the connecting portion 65 is clamped frictionally in the fastening plane B against the outer side of the inner casing 31.

The second limb 63 protrudes with the connecting portion 65 in the longitudinal direction beyond the first limb 61. As a result, the opening 66 can be spaced apart in the longitudinal direction from the fastening means 64 of the first limb.

The breakaway device is formed in the connecting portion 65 by the opening 66 open on one side and the fastening element 52.

In the event of a crash, a crash force F, which is marked schematically in FIG. 3 and moves the inner casing 31 in the longitudinal direction relative to the outer casing 33, to the right in FIG. 3, is on the inner casing 31. As a result, the retaining effect of the friction fit between the connecting portion 65 and the inner casing 31 is overcome. The fastening element 52 is moved out of the opening 62 in the longitudinal direction, as indicated with the arrow in FIG. 4, as a result of which the breakaway device is detached. Subsequent to this, the first limb 61 can, as the plastic deformation and energy absorption continue, pass through the shaped part 62.

### LIST OF REFERENCE SIGNS

1 steering column
2 support unit
21 securing means
3 setting unit
30 steering spindle
31 inner casing
32 fastening portion
33 outer casing
4 linear actuator
41 drive unit
42 threaded spindle
43 spindle nut
5 energy-absorption device
51 fastening element
52 fastening element
6 bending strip
61 first limb
62 bend
63 second limb
64 fastening means
65 connecting portion
66 opening
L longitudinal axis
B fastening plane

1-15. (canceled)

16. A steering column for a motor vehicle, comprising:
a second component which can be displaced in a longitudinal direction relative to a first component;
wherein attached between the first component and the second component is an energy-absorption element which comprises at least one U-shaped bending strip which has a first limb which extends in the longitudinal direction in a first plane, is secured to the first component, and is connected via a bend to a second limb which extends in a longitudinal direction in a second plane spaced apart from the first plane and is secured to the second component;
wherein a breakaway device is provided which is configured such that it breaks away when a predetermined crash force is exceeded and frees the first component to move relatively relative to the second component in a longitudinal direction;
wherein the breakaway device has a connection, detachable in a longitudinal direction, between the second limb and the first component.

17. The steering column as claimed in claim 16, wherein the connection is formed directly between the second limb and the first component.

18. The steering column as claimed in claim 16, wherein the connection is formed only between the second limb and the first component.

19. The steering column as claimed in claim 16, wherein the second limb has a connecting portion which has the breakable connection of the breakaway device.

20. The steering column as claimed in claim 19, wherein the connecting portion extends at least partially in the first plane.

21. The steering column as claimed in claim 19, wherein the second limb is formed with a step.

22. The steering column as claimed in claim 19, wherein the breakaway device is spaced apart from the first limb in the longitudinal direction.

23. The steering column as claimed in claim 19, wherein the connecting portion has a sliding shoe.

24. The steering column as claimed in claim 16, wherein an electromotive linear actuator is arranged between the first component and the second component.

25. The steering column as claimed in claim 16, wherein the first component and the second component comprise casings which can telescope in the longitudinal direction.

26. The steering column as claimed in claim 16, wherein the bending strip has a shaped sheet metal part.

27. An energy-absorption element for a steering column of a motor vehicle, comprising:
at least one U-shaped bending strip which has a first limb which extends in a first plane in a longitudinal direction and has first fastening means for connection to a first component of the steering column, and is connected via a bend to a second limb which extends in a longitudinal direction in a second plane spaced apart from the first plane and has second fastening means for connection to a second component of the steering column;
wherein the second limb has a connecting portion which extends at least partially in the first plane.

28. The energy-absorption element as claimed in claim 27, wherein the second limb is formed with a step.

29. The energy-absorption element as claimed in claim 27, wherein the connecting portion has a sliding shoe.

30. The energy-absorption element as claimed in claim 27, wherein the connecting portion protrudes from the first limb in the longitudinal direction.
